(19) United States
(12) Patent Application Publication
(10) Pub. No.: US 2020/0241368 A1
(43) Pub. Date: Jul. 30, 2020

(54) PRIVACY PROTECTION COMPONENT AND ADJUSTING METHOD, DISPLAY PANEL AND DISPLAY DEVICE

(71) Applicants: Chongqing BOE Optoelectronics Technology Co., Ltd., Chongqing (CN); BOE TECHNOLOGY GROUP CO., LTD., Beijing (CN)

(72) Inventors: Junhong Lu, Beijing (CN); Bo Xu, Beijing (CN); Can Shen, Beijing (CN); Jiang Cao, Beijing (CN); Haiyan Li, Beijing (CN); Shuai Hou, Beijing (CN)

(21) Appl. No.: 16/675,379

(22) Filed: Nov. 6, 2019

(30) Foreign Application Priority Data
Jan. 30, 2019 (CN) 201910092701.5

(51) Int. Cl. G02F 1/1343; G02F 1/1335

(52) U.S. Cl. CPC G02F 1/134336; G02F 1/133512

(57) ABSTRACT

A privacy protection component, a display panel and display device comprising the privacy protection component, and an adjusting method of the privacy protection component. The privacy protection component comprising a privacy protection substrate and a plurality of support structures. The privacy protection substrate is provided with a plurality of first electrodes and a plurality of second electrodes arranged in an array and distributed alternately. The plurality of support structures are hollow and filled with liquid crystals, and the plurality of support structures are located on the plurality of first electrodes respectively and extend away from the privacy protection substrate.

### RELATED APPLICATION

This application claims priority to Chinese patent application No. 201910092701.5 filed on Jan. 30, 2019, the entire contents of which are incorporated herein by reference.

### TECHNICAL FIELD

The present application relates to the field of display technologies, and specifically to a privacy protection component and an adjusting method, a display panel and a display device.

### BACKGROUND

With the continuous development of display technologies, the viewing angle of a display panel is becoming wider and wider. The viewing angle of the existing display panel is approximately 180 degrees. A user may view the content displayed on the display panel from various angles, and essentially achieve a viewing experience without dead angle. However, in public environments, unnecessary trouble caused by privacy leakage of the user may result due to the increase in viewing angle.

At present, in order to prevent privacy leakage, a privacy protection film is often added onto the display screen so as to converge the viewing angle. However, while effectively protecting privacy, this also brings problems such as reduced brightness and poor display effects of the display panel. Moreover, although the privacy protection film can protect privacy, when the user needs to share the display content with other users, he/she cannot switch from a privacy mode back to a normal mode, which reduces the user experience of the user. In addition, the price of a privacy protection film is high in the current market, which increases the manufacture costs of the display panel.

### SUMMARY

According to an exemplary embodiment, a privacy protection component is provided, the privacy protection component comprising: a privacy protection substrate and a plurality of support structures; wherein:

the privacy protection substrate is provided with a plurality of first electrodes and a plurality of second electrodes arranged in an array, and the plurality of first electrodes and the plurality of second electrodes are distributed alternately;

the plurality of support structures are hollow and filled with liquid crystals; and

the plurality of support structures are located on the plurality of first electrodes respectively and extend away from the privacy protection substrate.

In some exemplary embodiments, an orthogonal projection region of each support structure on the privacy protection substrate is smaller than or equal to that of each first electrode on the privacy protection substrate.

In some exemplary embodiments, a height of the support structure is 2 μm to 3 μm.

In some exemplary embodiments, a diameter or diagonal length of a cross-section of the support structure is 9 μm to 10 μm.

In some exemplary embodiments, a cross-sectional area of the support structure at both ends is greater than that in the middle.

In some exemplary embodiments, a material of the support structure comprises a transparent material.

In some exemplary embodiments, the plurality of first electrodes and the plurality of second electrodes are made of a same material, a material of the plurality of first electrodes is a transparent conductive material, and a material of the plurality of second electrodes is a transparent conductive material.

According to another exemplary embodiment, a display panel is provided, the display panel comprising: a first substrate and a second substrate arranged oppositely, and the privacy protection component according to the first aspect of the present application.

The privacy protection component is located on a side of the first substrate remote from the second substrate, and the plurality of support structures are located between the first substrate and the privacy protection substrate.

In some exemplary embodiments, a black matrix is arranged on a side of the first substrate close to the second substrate, and positions of the plurality of support structures are disposed corresponding to a position of the black matrix.

In some exemplary embodiments, orthogonal projections of the plurality of support structures on the first substrate are located within an orthogonal projection region of the black matrix on the first substrate.

In some exemplary embodiments, an orthogonal projection region of each support structure on the privacy protection substrate is smaller than or equal to that of each first electrode on the privacy protection substrate.

In some exemplary embodiments, a height of the support structure is 2 μm to 3 μm.

In some exemplary embodiments, a diameter or diagonal length of a cross-section of the support structure is 9 μm to 10 μm.

In some exemplary embodiments, a cross-sectional area of the support structure at both ends is greater than that in the middle.

In some exemplary embodiments, a material of the support structure comprises a transparent material.

In some exemplary embodiments, the plurality of first electrodes and the plurality of second electrodes are made of a same material, a material of the plurality of first electrodes is a transparent conductive material, and a material of the plurality of second electrodes is a transparent conductive material.

According to another exemplary embodiment, a display device is provided, the display device comprising the display panel according to the second aspect of the present application.

According to another exemplary embodiment, an adjusting method of a privacy protection component is provided, the adjusting method being applied to the privacy protection component according an exemplary embodiment. The adjusting method comprises: applying no electric field between the plurality of first electrodes and the plurality of second electrodes such that the liquid crystals in the plurality of support structures are in an opaque dark state.

In some exemplary embodiments, the adjusting method further comprises: applying an electric field with a set intensity between the plurality of first electrodes and the plurality of second electrodes such that the liquid crystals in the plurality of support structures are in a light-transmissive state with a set transmittance.

In the privacy protection component according to some exemplary embodiments, the support structures are hollow and filled with liquid crystals, and each of the support structures is located on a respective first electrode and extends away from the privacy protection substrate. Therefore, by applying an electric field between the plurality of first electrodes and the plurality of second electrodes and adjusting the intensity of the electric field, the deflection angle of the liquid crystal molecules can be adjusted, thereby realizing a privacy protection function. Besides, the privacy protection component according to exemplary embodiments can switch between a privacy mode and a normal mode, which improves the use experience of the user. Moreover, the privacy protection component according to exemplary embodiments can be manufactured by using existing processes and materials, which reduces the manufacture costs.

### BRIEF DESCRIPTION OF DRAWINGS

Exemplary embodiments will be further described below with reference to the drawings in a non-restrictive manner. In the drawings, similar reference signs generally refer to same or similar portions throughout. The drawings are not necessarily drawn to scale, but instead, they generally focus on illustrating the principle of the present application. In the drawings:

FIG. 1 is a schematic view of a privacy protection component according to an exemplary embodiment;

FIG. 2 is a schematic view of a privacy protection component in a privacy mode according to an exemplary embodiment;

FIG. 3 is a schematic view of a privacy protection component in a normal mode according to an exemplary embodiment;

FIG. 4 is a schematic structure view of first electrodes and second electrodes according to an exemplary embodiment;

FIG. 5 is a schematic structure view of a display panel according to an exemplary embodiment; and

FIG. 6 is a flow chart showing an adjusting method of a privacy protection component according to an exemplary embodiment.

### DETAILED DESCRIPTION

Exemplary embodiments will be described in detail below. Exemplary embodiments will be shown in the drawings, in which same or similar signs are used to indicate same or similar components or components having same or similar functions throughout. If a detailed description of the prior art is unnecessary for the indicated features of an exemplary embodiment, it will be omitted. The embodiments described below with reference to the drawings are exemplary, and they are only used for explaining the present application, instead of limiting the present application.

Those skilled in the art should understand that, unless otherwise defined, all terms used herein (including both technical terms and scientific terms) have the same meanings as the general understandings of one having ordinary skills in the art of the present application. It should be further understood that terms such as those defined in a general dictionary should be understood as having meanings consistent with those in the context of the prior art and should not be construed by using ideal or excessively formal meanings unless specifically defined as defined herein.

Terms involved in the present application will be introduced and explained firstly.

A privacy protection film is a film for preventing privacy leakage, which provides a fixed viewing angle to enable only a user in the front to view an image displayed on the screen, with anyone standing by seeing only a dark image.

At present, in order to prevent privacy leakage of the user, a privacy protection film is often attached to a display screen of a terminal device, and the privacy protection film generally has a viewing angle of 60 degrees, i.e., one can only see a dark image when standing right or left at an angle greater than 30 degrees from a direction perpendicular to the display screen, to achieve the effect of privacy protection. However, when the user needs to share the display content with other users, for example, in a sharing scene where he/she watches a movie together with friends, due to the presence of the privacy protection film, he/she cannot switch from a privacy mode to a normal mode, so the user's need for sharing the display content cannot be satisfied; besides, the price of the existing privacy protection film is high, which increases the manufacture costs.

The privacy protection component and adjusting method, display panel and display device provided in the present application aim to solve the above technical problems in the prior art.

Exemplary embodiments will be used to explain in detail the technical solution of the present application and how it solves the above technical problem.

FIG. 1 is a schematic view of a privacy protection component according to an exemplary embodiment. As shown in FIG. 1, the privacy protection component 10 comprises: a privacy protection substrate 101 and hollow support structures 102.

The privacy protection substrate 101 is provided with a plurality of first electrodes 1011 and a plurality of second electrodes 1012 arranged in an array, and the plurality of first electrodes 1011 and the plurality of second electrodes 1012 are distributed alternately. The support structures 102 are hollow and filled with liquid crystals 1021. The support structures 102 are located on the plurality of first electrodes 1011 respectively and extend away from the privacy protection substrate 101.

According to the privacy protection component in exemplary embodiments, the support structures 102 are filled with liquid crystals 1021; and the support structures 102 are located on the first electrodes 1011 and extend away from the privacy protection substrate 101, so an electric field can be applied between the first electrodes 1011 and the second electrodes 1012, and the deflection angle of the liquid crystals 1021 can be adjusted through adjustment of the intensity of the electric field so as to realize the privacy protection function and to switch between the privacy mode and the normal mode, which improves the use experience of the user. Moreover, the privacy protection component provided in exemplary embodiments can be manufactured by using existing processes and materials, which reduces the manufacture costs.

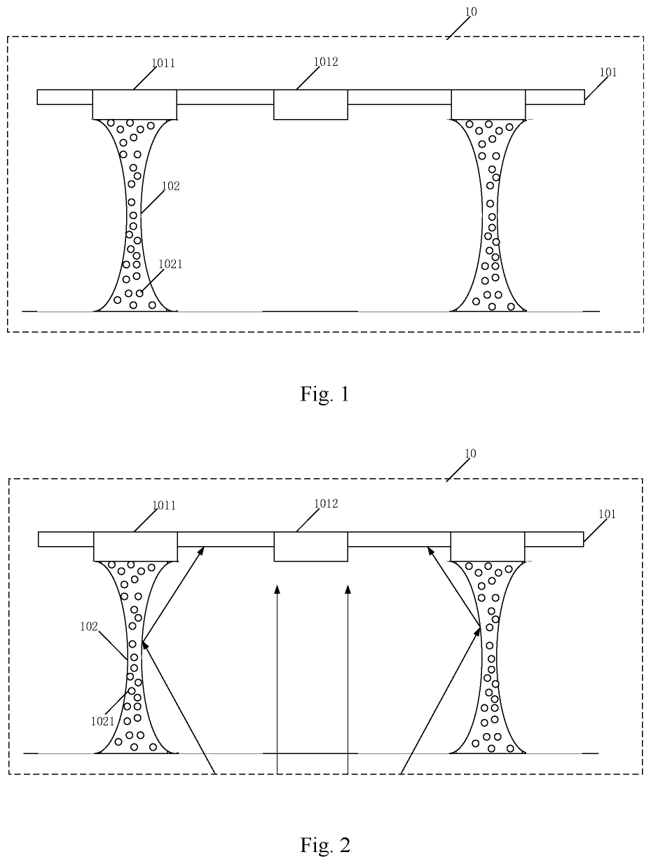

FIG. 2 is a schematic view of a privacy protection component in a privacy mode according to an exemplary embodiment.

As shown in FIG. 2, the first electrodes 1011 and the second electrodes 1012 may be connected with an external power supply respectively. When unenergized, the liquid crystals 1021 filled in the support structures 102 are disordered. When light is incident from one side of the privacy protection component 10, it cannot pass through the support structures 102 since the support structures 102 are filled with disordered liquid crystals 1021, while only part of the light is diffusely reflected to the display region by the disordered liquid crystals 1021, which increases the display brightness of the display region. The schematic propagation path of the light is indicated by the arrow direction in the drawing. In this case, the user can view the display content only within a viewing angle perpendicular to the privacy protection component 10, the display content cannot be viewed under the remaining viewing angles, and thus the privacy protection effect is achieved.

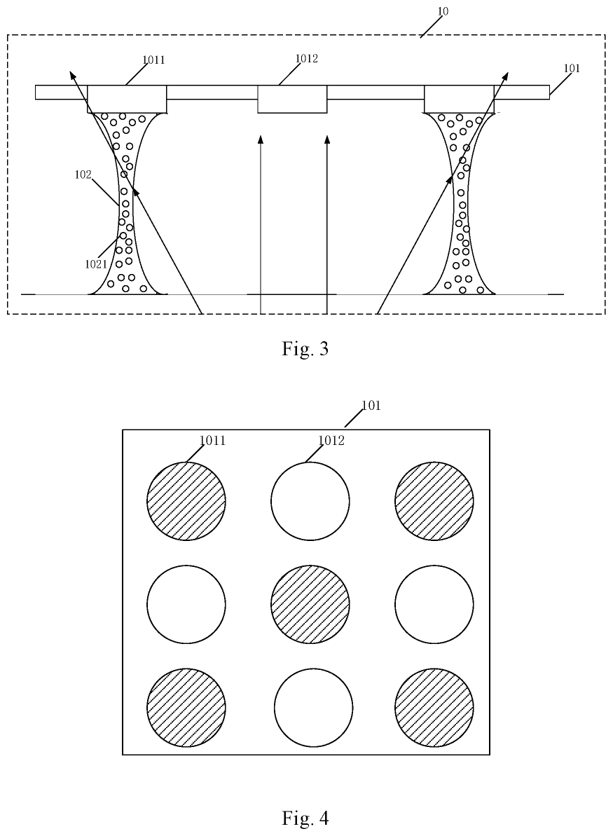

FIG. 3 is a schematic view of a privacy protection component in a normal mode according to an embodiment of the present application.

As shown in FIG. 3, when energized, an electric field is formed between the first electrodes 1011 and the second electrodes 1012. When driven by the electric field, the liquid crystals 1021 are ordered along a direction of the electric field. When light is incident from one side of the privacy protection component 10, it can pass through the support structures 102 under the birefringence effect of the liquid crystals 1021. The schematic propagation path of the light is indicated by the arrow direction in the drawing. Now the user can normally view the display content, and the viewing angle is restored to a normal display state of approximately 180 degrees. The user can view the display content from various angles without affecting the viewing effect at various angles, which realizes the switch between the privacy mode and the normal mode.

Optionally, in the privacy mode, the deflection angle of the liquid crystals 1021 can be adjusted and controlled through adjustment of the intensity of the electric field between the first electrodes 1011 and the second electrodes 1012, so as to control the transmittance of the liquid crystals 1021 and in turn control the width of the viewing angle. For example, when the liquid crystals 1021 in the support structures 102 begin to deflect, starting from an opaque state, the liquid crystals 1021 gradually refract light. As the transmittance of the liquid crystals 1021 continuously increases, the viewing angle gradually increases. When the electric field intensity reaches the maximum, the transmittance of the liquid crystals 1021 reaches the maximum, and the viewing angle is restored to the normal mode of approximately 180 degrees, which allows the user to view the display content from various angles.

Based on the privacy protection component provided in the above exemplary embodiments, exemplary embodiments will further describe the privacy protection component 10 provided in the above exemplary embodiments in detail with reference to the drawings.

Optionally, an orthogonal projection region of each support structure 102 on the privacy protection substrate 101 is smaller than or equal to that of each first electrode 1011 on the privacy protection substrate 101. Such arrangement can ensure that the support structures 102 do not affect the original transmittance.

FIG. 4 is a schematic structure view of first electrodes and second electrodes according to an exemplary embodiment.

As shown in FIG. 4, the first electrodes 1011 and the second electrodes 1012 are distributed alternately on the privacy protection substrate 101. The support structures 102 may be located on either the first electrodes 1011 or the second electrodes 1012, as long as a stable electric field can be generated between the first electrodes 1011 and the second electrodes 1012. In actual application, in order to ensure that the support structures 102 do not affect the original transmittance, an area of each support structure 102 in contact with the first electrode 1011 or the second electrode 1012 is smaller than or equal to that of the electrode.

Optionally, a height of the support structure 102 is 2 μm to 3 μm. Besides, a diameter or diagonal length of a cross-section of the support structure 102 is 9 μm to 10 μm.

It should be noted that the height and the cross-sectional area of the support structure 102 can influence the propagation direction of light in the privacy mode. In order to ensure that the entire thickness of the display panel comprising the privacy protection component is not excessively thick while achieving a good privacy protection effect, the height of the support structure 102 may be about 3 μm, and the diameter or diagonal length of the cross-section may be about 10 μm.

Optionally, a cross-sectional area of the support structure 102 at both ends is greater than that in the middle.

It should be noted that the shape of the support structure 102 may be a dumbbell having a cross-sectional area at both ends greater than that in the middle, or a cylinder or a cuboid having a cross-sectional area at both ends equal to that in is the middle. In order to ensure a better privacy protection effect, in actual application, the support structure 102 is in the shape of a dumbbell having a cross-sectional area at both ends greater than that in the middle.

Optionally, a material of the support structure comprises a transparent material.

It should be noted that in order to ensure the light transmittance of the support structure 102 in the normal mode, the material of the support structure 102 may be a transparent material.

Optionally, the first electrodes 1011 and the second electrodes 1012 are made of a same material, the material of the first electrodes 1011 is a transparent conductive material, and the material of the second electrodes 1012 is a transparent conductive material.

It should be noted that in order to reduce the material costs, the first electrodes 1011 and the second electrodes 1012 are made of a same material. In actual application, the material of the first electrodes 1011 and the second electrodes 1012 may be one of indium tin oxide or indium zinc oxide.

It should be understood that the privacy protection component provided in exemplary embodiments can be applied to a liquid crystal display panel, an organic light emitting diode display panel, or other types of display panels, which will not be listed exhaustively for simplicity.

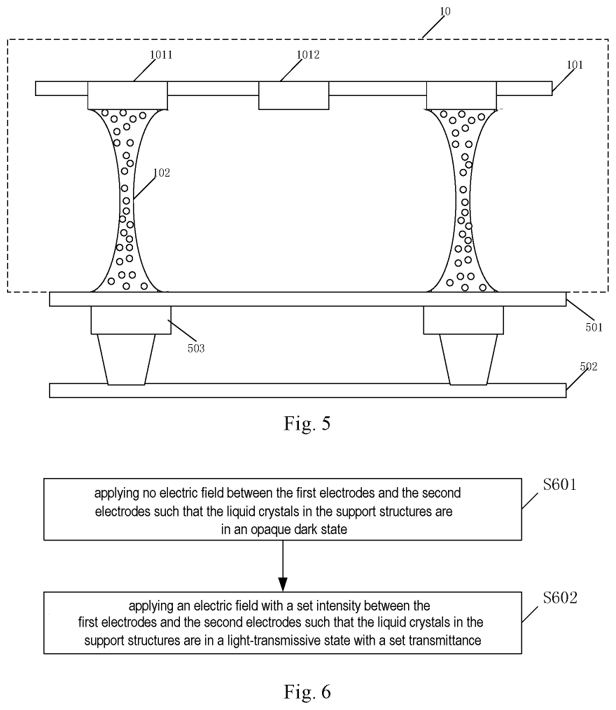

Based on a same inventive concept, a display panel is further provided in exemplary embodiments. FIG. 5 is a schematic structure view of a display panel according to an exemplary embodiment.

As shown in FIG. 5, the display panel comprises: a first substrate 501 and a second substrate 502 arranged oppositely, and the privacy protection component 10 provided according to the above exemplary embodiments.

The privacy protection component 10 is located on the first substrate 501 and remote from the second substrate 502. Besides, the support structures 102 are located between the first substrate 501 and the privacy protection substrate 101.

Optionally, a black matrix 503 is arranged on a side of the first substrate 501 close to the second substrate 502, and positions of the respective support structures 102 are disposed corresponding to a position of the black matrix 503.

It should be noted that during normal display, the black matrix 503 can shield light. In order to ensure the display effect, the positions of the support structures 102 are disposed corresponding to the position of the black matrix 503, so as to avoid shielding of the display content by the support structures 102 in the normal mode.

Optionally, orthogonal projections of the support structures 102 on the first substrate 501 are located within an orthogonal projection region of the black matrix 503 on the first substrate 501; or orthogonal projections of the support structures 102 on the first substrate 501 completely overlap an orthogonal projection region of the black matrix 503 on the first substrate 501.

The manufacture method of the display panel according to exemplary embodiments will be introduced briefly below. For example, the privacy protection component is in the shape of a dumbbell thick at both ends and thin in the middle, the first substrate is a color filter substrate and the second substrate is an array substrate.

Firstly, an array substrate and a color filter substrate are fabricated and assembled. The specific fabrication processes of the array substrate and the color filter substrate and the specific process of assembly are irrelevant to the substantive content of the present application, and will not be detailed herein for simplicity.

Next, a negative photoresist layer is coated on a surface of the color filter substrate remote from the array substrate, which forms a circular hollow structure by exposure after being pre-baked and then forms a cylindrical hollow support structure after being developed. The surface of the middle of the hollow cylindrical support structure is etched to form a dumbbell-shaped support structure.

Then, liquid crystals are injected into the dumbbell-shaped support structure such that the hollow part of the support structure is filled with liquid crystals. After that, a privacy protection substrate having first electrodes and second electrodes fabricated thereon is assembled with the color filter substrate having support structures formed thereon, thereby forming an integrated display panel having a privacy protection function.

The privacy implementation principle of the display panel having a privacy protection function according to exemplary embodiments is similar to that of the privacy protection component 10 according to the above exemplary embodiments, which will not be repeated herein for simplicity.

Based on the same inventive concept, a display device is further provided in exemplary embodiments, the display device comprising the display panel according to the above embodiments. The implementation principle of the display device is similar to that of the privacy protection component 10 according to the above embodiments, which will not be repeated herein for simplicity.

It can be understood that the display device provided in exemplary embodiments may be a device such as a cellphone, a computer, a tablet or a smart watch.

Based on the same inventive concept, an adjusting method of a privacy protection component is further provided in exemplary embodiments. FIG. 6 is a flow chart showing an adjusting method of a privacy protection component according to an exemplary embodiment.

As shown in FIG. 6, the adjusting method comprises steps S601-S602.

In step S601, no electric field is applied between the plurality of first electrodes and the plurality of second electrodes such that the liquid crystals in the plurality of support structures are in an opaque dark state.

In step S602, an electric field with a set intensity is applied between the plurality of first electrodes and the plurality of second electrodes such that the liquid crystals in the plurality of support structures are in a light-transmissive state with a set transmittance.

In step S601, in a privacy mode, no electric field is applied between the first electrodes and the second electrodes, the liquid crystals in the support structures are disordered and in an opaque dark state, so light cannot pass through the support structures, while only part of the light is diffusely reflected to the display region by the disordered liquid crystals, which increases the brightness of the display region. In this case, the user can view the display content only within a viewing angle perpendicular to the privacy protection component, the display content cannot be viewed under the remaining viewing angles, and thus a privacy protection function is achieved.

In step S602, in a normal mode, an electric field is formed between the first electrodes and the second electrodes. When driven by the electric field, the liquid crystals are ordered along a direction of the electric field and in a light-transmissive state, so when light is incident from one side of the privacy protection component, it can pass through the support structures under the birefringence effect of the liquid crystals, which allows the user to view the display content normally. In this case, the viewing angle is restored to approximately 180 degrees, which allows the user to view the display content from various angles without affecting the viewing of the content, so the switch between the privacy mode and the normal mode is realized.

It can be understood that in step S602, an electric field of a preset intensity may be applied between the first electrodes and the second electrodes. Since the intensity of the electric field corresponds to the deflection angle of the liquid crystals, the deflection angle of the liquid crystals may be adjusted through adjustment of the intensity of the electric field, such that the liquid crystals exhibit a set transmittance, thereby achieving adjustment of the viewing angle.

It should be noted that, in steps S601 and S602, although the steps in the flow chart of the drawing are displayed sequentially as indicated by the arrows, they are not necessarily executed sequentially in the order indicated by the arrows. For example, step S601 may be executed individually, and when it is executed so, the privacy protection component is in a privacy mode; and step S602 may also be executed individually, and when it is executed so, the privacy protection component can achieve a privacy mode of different angles and a normal mode through adjustment of the transmittance of the liquid crystals. When the steps are executed sequentially, the switch between the privacy mode and the normal mode is realized.

To sum up, according to the privacy protection component in exemplary embodiments, an electric field can be applied between the first electrodes and the second electrodes, and the deflection angle of the liquid crystals is adjusted through adjustment of the intensity of the electric field so as to realize the privacy protection function and the switch between the privacy mode and the normal mode, which improves the use experience of the user. Moreover, the privacy protection component provided in exemplary embodiments can be manufactured by using the existing process and materials, which reduces the manufacture costs.

Those skilled in the art can understand, in the description of the present application, it should be understood that directional or positional relations indicated by terms such as “center”, “up”, “down”, “front”, “back”, “left”, “right”, “vertical”, “horizontal”, “top”, “bottom”, “inner” and “outer” are directional or positional relations shown on the basis of the drawings. They are used only for describing the present invention and simplifying the description, instead of indicating or implying that the indicated devices or elements must be orientated specifically, or constructed and operated in a specific orientation, so they cannot be construed as limiting the present invention.

Terms such as “first” and “second” are used only for descriptive purposes and should not be construed as indicating or implying relative importance or hinting at the number of the indicated technical features. Thereby, features defined by “first” and “second” can comprise one or more such features explicitly or implicitly. In the description of the present invention, unless otherwise stated, “a plurality of” means two or more.

It should be understood that, although the steps in the flow chart of the drawings are displayed sequentially as indicated by the arrows, they are not necessarily executed sequentially in the order indicated by the arrows. Unless otherwise explained explicitly, there is no strict sequence limitation on the execution of the steps; instead, the steps may be executed in other sequences. Moreover, at least part of the steps in the flow chart of the drawings may comprise a plurality of sub-steps or a plurality of stages. The sub-steps or stages are not necessarily executed at the same time, but may be executed at different times, and they are not necessarily executed sequentially, but may be executed alternately with other steps or at least part of the sub-steps or stages of other steps.

What is mentioned above is only part of the exemplary embodiments, and it should be pointed out that, for one having ordinary skills in the art, several improvements and modifications can also be made without deviating from the principles of the present application, and such improvements and modifications should also be deemed as falling within the protection scope of this disclosure.

1. A privacy protection component, comprising: a privacy protection substrate and a plurality of support structures, wherein:
the privacy protection substrate is provided with a plurality of first electrodes and a plurality of second electrodes arranged in an array, and the plurality of first electrodes and the plurality of second electrodes are distributed alternately;
the plurality of support structures are hollow and filled with liquid crystals; and
the plurality of support structures are located on the plurality of first electrodes respectively and extend away from the privacy protection substrate.

2. The privacy protection component according to claim 1, wherein an orthogonal projection region of each support structure on the privacy protection substrate is smaller than or equal to that of each first electrode on the privacy protection substrate.

3. The privacy protection component according to claim 2, wherein a height of the support structure is 2 μm to 3 μm.

4. The privacy protection component according to claim 2, wherein a diameter or diagonal length of a cross-section of the support structure is 9 μm to 10 μm.

5. The privacy protection component according to claim 2, wherein a cross-sectional area of the support structure at both ends is greater than that in the middle.

6. The privacy protection component according to claim 1, wherein a material of the support structure comprises a transparent material.

7. The privacy protection component according to claim 1, wherein the plurality of first electrodes and the plurality of second electrodes are made of a same material, a material of the plurality of first electrodes is a transparent conductive material, and a material of the plurality of second electrodes is a transparent conductive material.

8. A display panel comprising: a first substrate and a second substrate arranged oppositely, and the privacy protection component according to claim 1, wherein:
the privacy protection component is located on a side of the first substrate remote from the second substrate, and the plurality of support structures are located between the first substrate and the privacy protection substrate.

9. The display panel according to claim 8, wherein a black matrix is arranged on a side of the first substrate close to the second substrate, and positions of the plurality of support structures are disposed corresponding to a position of the black matrix.

10. The display panel according to claim 9, wherein orthogonal projections of the plurality of support structures on the first substrate are located within an orthogonal projection region of the black matrix on the first substrate.

11. The display panel according to claim 8, wherein an orthogonal projection region of each support structure on the privacy protection substrate is smaller than or equal to that of each first electrode on the privacy protection substrate.

12. The display panel according to claim 11, wherein a height of the support structure is 2 μm to 3 μm.

13. The display panel according to claim 11, wherein a diameter or diagonal length of a cross-section of the support structure is 9 μm to 10 μm.

14. The display panel according to claim 11, wherein a cross-sectional area of the support structure at both ends is greater than that in the middle.

15. The display panel according to claim 8, wherein a material of the support structure comprises a transparent material.

16. The display panel according to claim 8, wherein the plurality of first electrodes and the plurality of second electrodes are made of a same material, a material of the plurality of first electrodes is a transparent conductive material, and a material of the plurality of second electrodes is a transparent conductive material.

17. A display device, comprising the display panel according to claim 8.

18. An adjusting method of a privacy protection component, the privacy protection component comprising: a privacy protection substrate and a plurality of support structures, wherein: the privacy protection substrate is provided with a plurality of first electrodes and a plurality of second electrodes arranged in an array, and the plurality of first electrodes and the plurality of second electrodes are distributed alternately; the plurality of support structures are hollow and filled with liquid crystals; and the plurality of support structures are located on the plurality of first electrodes respectively and extend away from the privacy protection substrate, and the adjusting method comprising:
applying no electric field between the plurality of first electrodes and the plurality of second electrodes such that the liquid crystals in the plurality of support structures are in an opaque dark state.

19. The adjusting method of a privacy protection component according to claim 18, further comprising:
applying an electric field with a set intensity between the plurality of first electrodes and the plurality of second electrodes such that the liquid crystals in the plurality of support structures are in a light-transmissive state with a set transmittance.
